(19) United States
(12) Patent Application Publication
(10) Pub. No.: US 2006/0005141 A1
(43) Pub. Date: Jan. 5, 2006

(54) System, method, computer program product, and storage device for enabling a user to manipulate a user interface

(75) Inventors: Vincentius Paulus Buil, Eindhoven (NL); Marco Van Leeuwen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/530,620

(22) PCT Filed: Oct. 7, 2003
(86) PCT No.: PCT/IB03/04398

§ 371 Date: Apr. 7, 2005

(30) Foreign Application Priority Data
Oct. 9, 2002 (EP) 02079225.5

(51) Int. Cl. G06F 17/00

(52) U.S. Cl. 715/764

(57) ABSTRACT

The invention relates to a system for enabling a user to manipulate a user interface to make a selection from a first item and/or a collection comprising a second item, and the system comprises: generating means (116) conceived to generate a generated-collection that comprises the first item that belongs to the selection; and presentation means (108) conceived to present the user, through the user interface, an overview of the generated-collection and/or the collection that belongs to the selection.

The invention relates to a system for enabling a user to manipulate a user interface to make a selection from a first item and/or a collection comprising a second item.

The invention further relates to a method for enabling a user to manipulate a user interface to make a selection from a first item and/or a collection comprising a second item.

The invention further relates to a computer program product comprising program code means designed to perform such a method.

The invention further relates to a storage device comprising such a computer program product.

Many software applications running on personal computers, settop boxes, and other computing devices enable the user to search for collections and items comprised within these collections that meet certain criteria. Examples are the search for files and folders, songs and albums of a certain artist, photo's and photo albums of a certain event, etc. Often, the collections and items that meet the criteria are presented to a user into one overview. This overview then comprises the collections side by side with the items, thereby enabling a user to select content that is available on different levels.

It is an object of the invention to provide a system according to the preamble that organizes a collection in an improved way. In order to achieve this object, the system comprises: generating means conceived to generate a generated-collection that comprises the first item that belongs to the selection; and presentation means conceived to present the user, through the user interface, an overview of the generated-collection and/or the collection that belongs to the selection By providing a user with such an overview, the user can be provided with a consistent view upon collections and items. For example, in the case that a user wants to select all music albums of a certain artist, the user can be provided with all music albums of that artist and with a generated album that comprises songs of the artist that are for example present upon different albums comprising a collection of songs of several artists. In this way, the user is provided with a user interface, that can show real albums and a generated album that comprises songs of the artist.

An embodiment of the system is described in claim 2. By labeling both the collections and the items that are comprised within the collections, a user can select collections according to the labels. For example, in the case that the collections are photo-albums and the items are photos, there can be photo albums that are labeled “marriage” because they cover complete marriages and there can be individual photos of a marriage that are labeled “marriage” themselves but are not present within a photo album labeled “marriage”. In this case, if the user wants to select all albums and photos of marriages, the user can be provided with photo albums that cover the complete marriages and a generated photo album that contains the individual photos of marriages.

It is a further object of the invention to provide a method according to the preamble that organizes a collection in an improved way. In order to achieve this object the method comprises: generating a generated collection that comprises the first item that belongs to the selection; and presenting the user, through the user interface, an overview of the generated-collection and/or the collection that belongs to the selection.

A further embodiment of the method according to the invention is described in claim 4.

An embodiment of the computer program product designed to perform the method according to the invention is described in claim 5.

An embodiment of the storage device comprising a computer program product according to the invention is described in claim 6.

These and other aspects of the invention will be apparent from and elucidated with reference to the embodiments described hereinafter as illustrated by the following Figures:

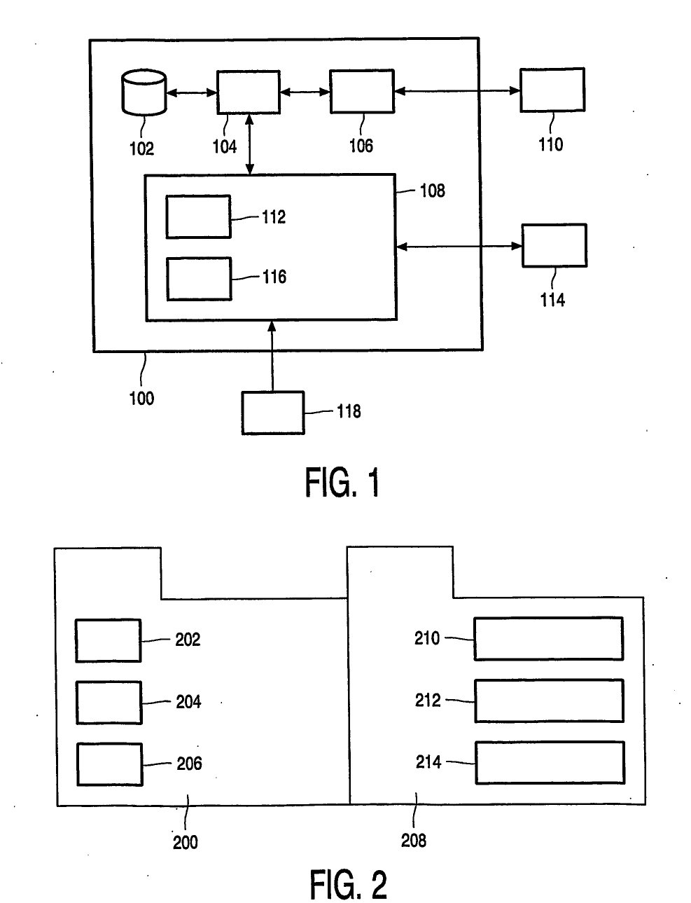

FIG. 1 illustrates a diagram of a consumer entertainment system as a data processing system embodying the invention;

FIG. 2 illustrates an example of a screen representation of a selection according to the invention.

Nowadays, the file system of personal computer is organized into files and folders. Usually, a user groups files into folders because the files have something in common. For example, the files all relate to the same subject. If a file relates to more than one subject, a copy of the file can be placed into a separate folder for each subject. In the case that a user wants to organize the files according to a lot of different subjects and the files do also belong to a number of different subjects, a lot of copies of one file must be made. Thus, disk-capacity is used to store numeral copies of the same content, just to enable a user to organize the files into folders upon subject.

FIG. 1 illustrates a diagram of a consumer entertainment system as a data processing system embodying the invention. The system comprises a data processing system 100 for reproducing content to a user. The data processing system 100 comprises, a mass storage 102, a microprocessor 104, an audio/video (A/V) processor 106 and a graphical user interface (GUI) software module 108. The A/V processor 106 is connected to an audio-video system 110, which can reproduce audio and video content through a video display and loudspeakers (not shown).

The GUI 108 comprises graphical engine 112 for presenting graphical information on a graphical display 114. The graphical display 114 and the audio-video system 110 may be combined to share e.g. the display, or may be integrated into the data processing system 100. The mass storage 102 comprises a database describing multimedia content, such as photo albums holding photos, music albums (CDs) holding songs, etc. In such a database both the albums and the items may be tagged with certain labels holding information on the content, such as genre, artist, year, event, place, etc. The GUI 108 further comprises computer readable code 116 designed to generate a collection that comprises items that are tagged with a certain label. For example, a user can request the GUI 108 to give an overview of classical music albums, or to give an overview of classical music albums of the year 2002. A user may interact with the data processing system 100 through input device 118, which may comprise a keyboard, and/or a mouse, and/or a remote control etc.

The data processing system 100 may be dedicated to recording and/or playing audio files to and from the mass storage 102 respectively, thus acting as an audio jukebox. Instead of audio files, also video files, or interactive content may be reproduced. The system may be embodied by a personal computer or a dedicated jukebox device. The present invention is particularly useful for making selections from large collections of content items. However, it is not limited to such applications.

The invention may also be used for making selections from broadcast programs, internet radio programs, digital photos, product information etc. For that purpose, the data processing system 100 may be embodied by a broadcast receiver or an internet access device with similar components as depicted in FIG. 1, and additional means for receiving broadcast signals, accessing the internet, etc. The invention can also be advantageously applied for controlling regular software applications running, e.g. for folders and files.

FIG. 2 illustrates an example of a screen representation of a selection according to the invention. The screen representation is suitable for a display screen of any size. The example screen representation considers searching for a photo collection. Logically, a photo album comprises one or more photos and a photo can be present in one or more photo albums. A photo album further can be labeled according to an event, the place, year, month, person, object, etc. These labels can also be used for the individual photos. A user assigns the labels to the photo albums and to the photos. However, not each individual photo and photo album needs to be labeled.

The first tab 200 enables a user to specify the values of the labels according to which the photo albums and photos should be presented to the user. For example, the first tab 200 can comprise the labels “event” 202, “place” 204 and “person” 206. The user can then use for example the input device to fill in a value for the labels, or the user may choose a value from a predefined list that comprises all values that are used for the labels. If the user wants to be presented with all albums and photos of which the label “event” has value “holiday”, then the second tab 208 gives an overview of all albums and photos that comply. For example, the collections 212, and 214 are photo albums of which the “event” label has value “holiday”. These photo albums comprise individual photos that are assigned intentionally to these albums by the user. In contrast, collection 210 is a system-generated photo album that comprises all photos that are individually labeled with an “event” label of value “holiday”. A photo album can have more then one label. For example, the photo album labeled “holiday” can also have the label “Greenland”. The same holds for individual photos. Consider the case that a photo album is labeled both “holiday” and “Greenland” and that this photo album contains a photo labeled “Greenland”. Now, if a user uses a selection-criterion “Greenland”, a system-generated photo album is created containing the photo labeled “Greenland” and to the user this system-generated photo album is presented together with the photo album labeled “Greenland” and “holiday”. However, if a user uses a selection-criterion “holiday”, the user is presented with only the photo album labeled “Greenland” and “holiday”. The user can also be presented with an empty system-generated photo album, to indicate that there are no photos available with a label “holiday”. This illustrates, that combinations of values are also possible. For example, a combination of “event” with value “holiday” and “person” with value “peter”. It is also possible, that there are photos that do not belong to a photo album. In the case that a photo is present in both a “normal” album and a system-generated album after applying the selection criterion, the photo can be present as a copy in both albums or as a reference to the original photo. This is a matter of implementation that is known to the skilled person. The same holds for the case that the collection comprises sub-collections, i.e. the collection is recursive. In this case the sub-collections and the collections of which the labels match the selection criterion can be presented to the user at the same level. Thus if there is a sub-collection, a collection and a photo of which the respective labels match the selection criterion, the user interface can show a generated collection comprising the photo, the collection and the sub-collection.

As further feedback to the user, each collection can be annotated with a number indicating the number of photos that are comprised within the album.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. A system for enabling a user to manipulate a user interface to make a selection from a first item and/or a collection comprising a second item, and the system comprises:
generating means conceived to generate a generated-collection that comprises the first item that belongs to the selection; and
presentation means conceived to present the user, through the user interface, an overview of the generated-collection and/or the collection that belongs to the selection.

2. A system for enabling a user to manipulate a user interface according to claim 1, wherein a selection-criterion defines the selection, the first item is labeled by an item-label, the collection is labeled by a collection-label; and
the generated-collection comprises the first item of which the item-label matches the selection-criterion; and
the overview comprises the generated-collection and the collection of which the collection-label matches the selection-criterion.

3. A method for enabling a user to manipulate a user interface to make a selection from a first item and/or a collection comprising a second item, and the method comprises:
generating a generated collection that comprises the first item that belongs to the selection; and
presenting the user, through the user interface, an overview of the generated-collection and/or the collection that belongs to the selection.

4. A method for enabling a user to manipulate a user interface according to claim 3, wherein a selection-criterion defines the selection, the first item is labeled by an item-label, the collection is labeled by a collection-label; and
the generated collection comprises the at least one item of which the item-label matches the selection-criterion; and
the overview comprises the generated-collection and the collection of which the collection-label matches the selection-criterion.

5. Computer program product comprising program code means designed to perform the method according to claim 3.

6. Storage device comprising the computer program product according to claim 5.
